(19) United States
(12) Patent Application Publication
(10) Pub. No.: US 2023/0265293 A1
(43) Pub. Date: Aug. 24, 2023

(54) CONTINUOUS SELF-DISINFECTING AND PATHOGEN ERADICATING COATING, ARTICLE OF MANUFACTURE WITH THE COATING AND METHOD OF APPLICATION

(71) Applicant: Kismet Technologies LLC, Winter Park, FL (US)

(72) Inventors: Christina H. Drake, Winter Park, FL (US); Scott Hoos, Apollo Beach, FL (US)

(21) Appl. No.: 18/090,693

(22) Filed: Dec. 29, 2022

Related U.S. Application Data
(60) Provisional application No. 63/313,381, filed on Feb. 24, 2022.

(51) Int. Cl. C09D 5/14; C09D 7/61; C09D 7/40

(52) U.S. Cl. CPC C09D 5/14; C09D 7/61; C09D 7/67

(57) ABSTRACT

A long-lasting coating composition that comprises a metal-modified cerium oxide nanoparticles (mCNPs) ingredient selected from a group consisting of predominantly 3+ surface charge and predominantly 4+ surface charge. The m is an antimicrobial promoting metal. The coating composition includes a paint, where the mCNPs ingredient has a weight percent loading less than about 1 weight % in a mixture including the paint that is a durable adhesive coating once cured. The cured paint has a strong bond with the surface to which it is adhered.

### CROSS-REFERENCE TO RELATED APPLICATIONS

This application claims priority benefit of U.S. Provisional Application No. 63/313,381, titled “CONTINUOUS SELF-DISINFECTING AND PATHOGEN ERADICATING COATING, ARTICLE OF MANUFACTURE WITH THE COATING AND METHOD OF APPLICATION,” filed Feb. 24, 2022, incorporated herein by reference in its entirety.

### BACKGROUND

Embodiments relate to the field of medical science and, more specifically, the field of continuous self-disinfecting and pathogen eradicating coatings using a coating composite with metal-modified nanoparticles. The embodiments relate to an article of manufacture that includes a continuous self-disinfecting and pathogen eradicating coating.

The transmission of nosocomial pathogens within hospitals is largely due to spread by healthcare workers' hands as they touch multiple surfaces and patients. For example, methicillin-resistant Staphylococcus aureus (MRSA) contamination of door handles in hospitals has been estimated between 1 and 6×10³ CFU (colony forming units). The presence of blood and pus, protein, serum and sputum provides organic protection that significantly increases bacterial survival and persistence on a surface for up to two weeks in some cases. Unlike bacteria, viruses present unique issues in disinfection.

Bacteria are living cells and must have conditions present for the bacteria to continue to thrive. Residual sanitizers, such as Microban24, suppress conditions for survival and growth of bacteria, but do not kill viruses. Viruses are non-living and can remain infective if they remain intact until they reach a host.

Disinfectants deal with “deactivating” viruses as well as bacteria. Current spray disinfectants only disinfect at the time of application and do not provide protection after application. This creates a situation where areas with high touch surfaces or high patient throughput need to constantly have disinfectant reapplied to stop pathogen spread. The use of ultraviolet (UV) lights has a similar shortcoming to spray disinfectants in that they only disinfect when they are in use. Because UV light is not safe for exposure to humans, it cannot be used when people are present. This creates a high chance for infection to be spread by contact with surfaces in emergency rooms, intensive care units, and other healthcare scenarios where people are constantly present.

### BRIEF SUMMARY

The embodiments related to a continuous self-disinfecting and pathogen eradicating coatings that prevent microbe colonization of a surface using a long-lasting coating composition with metal-modified nanoparticles and method of disinfecting a surface. The embodiments relate to an article of manufacture that includes a continuous self-disinfecting and pathogen eradicating coating on an article after the article is installed in an environment.

An aspect of the embodiments includes a coating composition that includes a mCNPs ingredient selected from a group consisting of predominantly 3+ surface charge and predominantly 4+ surface charge, where m is an antimicrobial promoting metal. The coating composition includes a paint, where the mCNPs ingredient has a weight percent loading less than about 1 weight % in a mixture including the paint that is a durable adhesive coating once cured.

The coating composition may comprise a metal-modified cerium oxide nanoparticles (mCNPs) ingredient with predominantly 3+ surface charge and a urethane-based clearcoat where the mCNPs ingredient has a weight percent loading less than about 1 weight % in a mixture including the urethane-based clearcoat that is a durable adhesive coating once cured.

The coating composition may comprise metal-modified cerium oxide nanoparticles (mCNPs) ingredient with predominantly 4+ surface charge and a clearcoat urethane where the mCNPs ingredient has a weight percent loading less than about 1 weight % in a mixture including the clearcoat urethane.

The embodiments related to an article of manufacture includes a surface and a coating composition that is cured or dried on the surface. The coating composition is self-disinfecting and pathogen eradicating. The surface may be hard or soft.

A method of disinfecting a surface comprises coating the surface with a coating composition with metal-modified nanoparticles, and curing the coating composition to form a self-disinfecting, mechanically rigid and adherent coating on the surface which also eradicates bacteria biofilms at least by 99.9% or >99.999%. The coating composition may be cured with a UV light or harden by drying.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

To easily identify the discussion of any particular element or act, the most significant digit or digits in a reference number refer to the figure number in which that element is first introduced.

FIG. 1 illustrates a surface of an article coated with a coating composition in accordance with one embodiment.

FIG. 2A illustrates a toilet seat coated with a coating composition in accordance with one embodiment.

FIG. 2B illustrates a door with a door handle coated with a coating composition in accordance with one embodiment.

FIG. 3A illustrates furniture coated with a coating composition in accordance with one embodiment.

FIG. 3B illustrates fabric coated with a coating composition in accordance with one embodiment.

FIG. 3C illustrates an interior wall of a building coated with a coating composition and having a door and a window in accordance with one embodiment.

FIG. 4 illustrates a flowchart of a process for coating a surface in accordance with one embodiment.

FIG. 5 illustrates a graph of a vital titer such as rhinovirus over treated with AgCNP2 in accordance with one embodiment.

FIGS. 6A-6C illustrate three graphs of MRSA, Staphylococcus aureus, and Pseudomonas aeruginosa treated with AgCNP2 in accordance with one embodiment.

FIG. 7 illustrates a bar graph Pseudomonas aeruginosa biofilm treated with AgCNP2 in accordance with one embodiment.

FIG. 8A illustrates a flow diagram of a testing process for viruses such as SARS-CoV-2 surrogate OC43 coronavirus in accordance with an embodiment.

FIG. 8B illustrates a graphical representation of a test of AgCNP1 and AgCNP2 dried on a slide after a 2-hour incubation with SARS-CoV-2 surrogate OC43 coronavirus.

FIG. 9 illustrates a graphical representation of a test that includes fibers treated with a solution including 0.01 wt % of AgCNP2 with a polymeric binder (right) compared to untreated fibers (left) after a 2-hour incubation with Rhinovirus 14 (left and right) on dry fabric.

FIG. 10 illustrates a graphical representation of a test that includes fibers treated with a solution including 0.01 wt % AgCNP2 and a polymeric binder (right) compared to untreated fabric (left) after a 2-hour incubation with Parainfluenza virus type 5 (left and right) on dry fibers.

FIGS. 11A-11C illustrate photographs of S. epidermidis dried on a control surface coupons shown in triplicate (3 plate sections) at 15, 60 and 120 minutes, respectively, of bacterial challenge.

FIGS. 12A-12C illustrate photographs of S. epidermidis dried on NanoRAD (AgCNP2 in polyurethane) treated coupons shown in triplicate (3 plate sections) at 15, 60 and 120 minutes, respectively, of bacterial challenge.

FIG. 13 illustrates a photograph of S. epidermidis on a dilution plate.

### DETAILED DESCRIPTION

The inventor has surprisingly determined that metal-modified cerium oxide nanoparticles (mCNPs), as described herein, in NanoRAD coatings provide non-stop, continuous protection against viruses and bacteria, even when a surface is not pristine (free from organic matter). This is a common problem with many disinfection approaches that lose efficacy when protective organic matter is present with the bacteria or virus.

NanoRAD coatings provide continuous virus and bacteria protection even when the surface is not pristine and has organic matter present that typically protects bacteria and viruses. NanoRAD coatings also prevent biofilm formation and decrease existing biofilms. Because of how long the NanoRAD coatings are present on a surface, a method is included for validation of coating coverage after several weeks or months of use.

The inventor has surprisingly determined that NanoRAD coatings have the ability to eradicate pathogens (including MRSA and norovirus) even with repeat exposure to a full viral or bacterial load on a non-pristine NanoRAD treated surface within 2 hours. NanoRAD coatings are also able to disinfect in the presence of biofilms, with eventual eradication of even aggressive biofilms. NanoRAD coatings are intended for use from months up to a year and are able to resist even wet chemical abrasion with other disinfectants such as bleach or hydrogen peroxide without loss of performance. Temporary NanoRAD films described in WO2021222779A1, titled “DISPENSABLE NANOPARTICLE BASED COMPOSITION FOR DISINFECTION” which is incorporated herein by reference, but do not have mechanical or chemical resistance as described herein. NanoRAD coatings make use of a fluorescing additive that is UV activated within the coating and emits visible light. Coating coverage and amount can be identified using an image processing technique assessing brightness per area of the antimicrobial coating. Alternate to a fluorescing additive, the NanoRAD coatings may make use of NIR to visible up-conversion nanomaterials (UCNPs).

NanoRAD coatings are unconventional in its ability to eradicate pathogens even with protective organic matter present, either on the surface or with the pathogen. This is typically where residual antimicrobial technologies fail to disinfect, much less eradicate pathogens. This is an important feature for surfaces in hospitals where you may have several different persons interacting with a surface before the surface can be cleaned or recleaned. NanoRAD coatings are able to work even under these tough conditions, drastically reducing the likelihood of infection.

The inventor has surprisingly determined that another aspect of the NanoRAD coatings is that it eradicates biofilms and prevents growth of new biofilms. This means that even on a surface with an existing biofilm present, if not removed before the NanoRAD coating is applied, would be eradicated by the NanoRAD coating.

Another unconventional aspect of NanoRAD coating is the ability to bleach or aggressively chemically clean the coating without losing coating integrity. This allows the NanoRAD coating to provide essentially continuous self-cleaning or self-disinfecting properties while enabling the NanoRAD coating to be cleaned of bodily fluids, other surface contaminates, or organic matter, during the useful life (UL) of the coating. During cleaning to remove organic material such as bodily fluids, light abrasion may be applied without affecting the effectiveness of the NanoRAD coating. The NanoRAD coating is a durable adhesive coating which is resistant to chemical cleaning.

The NanoRAD coating can be cleaned with other cleaners and spray-on disinfectants to clean bodily fluids, organic matter, dirt, food, and other debris using a paper towel, cloth, or cleaning wipe.

The NanoRAD coating, as described herein, is self-disinfecting and has the ability to eradicate biofilms or other bacteria on surfaces below the NanoRAD coating that may be present, which prevents the biofilm or bacteria from growing under the coating, through the coating or around edges of the coating.

The NanoRAD coatings, as described herein, have applications for public and private building, including hospitals, offices, hotels, residences, vacation rentals, retail stores, by way of non-limiting examples. NanoRAD coatings also have applications on ships and marine environments where eradication of pathogens is needed or prevention of colonization of a surface by bacteria or similar organism.

### Definitions

Unless specifically stated or obvious from context, as used herein, the term “about” is understood as within a range of normal tolerance in the art, for example, within 2 standard deviations of the mean. “About” can be understood as within 30%, 25%, 20%, 15%, 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term “about.”

As used herein, the term “composition” or “composite” as used herein refers to a product that includes ingredients such as one or more of chemical elements, diluent, binder, additive, or constituent in specified amounts, in addition to any product which results, whether directly or indirectly, from a combination of the ingredients in the specified amounts.

The term “prevention” or “preventing” of a disorder, disease, or condition as used herein refers to, in a statistical sample, a measurable or observable reduction in the occurrence of the disorder, disease or condition in the treated sample set being treated relative to an untreated control sample set, or delays the onset of one or more symptoms of the disorder, disease or condition relative to the untreated control sample set.

As used herein, the term “subject,” “individual” or “patient” refers to a human, a mammal, or an animal.

The term “metal-modified cerium oxide nanoparticles,” “metal-modified ceria nanoparticles,” or “mCNPs” as used herein refers to cerium oxide nanoparticles coated with or otherwise bound to an antimicrobial promoting metal such as silver, gold, copper, platinum, nickel, zinc, iron, titanium, ruthenium, vanadium, and the like. The term “mCNPs” may include AgCNP2, as described herein, and sometimes referred to as a NanoRAD ingredient. In an embodiment, the metal-associated cerium oxide nanoparticles comprise a particle size in the range of 3 nm-20 nm, with a preferred range from 10 nm-20 nm. The term “mCNPs” may also include AgCNP1 (i.e., metal-associated cerium oxide nanoparticles) comprising a particle size or diameter in the range of about 15 nm to 25 nm. The mCNPs may include metal-associated cerium oxide nanoparticles with a preferred range of 25 nm to 35 nm. AgCNP1, as described herein, may sometimes be referred to as a NanoRAD ingredient. The “mCNPs,” as described herein, are a NanoRAD ingredient.

As sometimes used herein, cerium oxide nanoparticles is referred to as “nanoceria.”

The term “predominant 4+ surface charge” refers to the concentration of cerium ions on the surface and means that the [Ce3+]:[Ce4+] ratio on the surface of the cerium oxide nanoparticle is less than 50%. In a specific example, cerium oxide nanoparticles having a predominant 4+ surface charge have a [Ce3+]:[Ce4+] ratio that is 40% or less. The term “predominant 3+ surface charge” means that the [Ce3+]:[Ce4+] ratio on the surface of the cerium oxide nanoparticle is greater than 50%.

The term “predominant 3+ surface charge” means that the [Ce3+]:[Ce4+] ratio on the surface of the cerium oxide nanoparticle is greater than 50%. In a specific example, the [Ce3+]:[Ce4+] ratio is greater than 60%.

The term “wet chemical synthesis” refers to a bottom-up method of making CNPs that involves dissolving a cerium precursor salt in water followed by addition of hydrogen peroxide. In a specific example, the CNPs form crystals and are stabilized over a predetermined time period, typically at least 15-30 days.

The term coating is distinct from the term film as it implies a mechanically rigid and adherent structure to the treated article that cannot be easily removed from the article by mechanical or chemical means.

### Metal-Modified Cerium Oxide Nanoparticle (AgCNP1)

The metal modified CNPs are created using a forced hydrolysis reaction followed by a post synthesis digestion process. The post synthesis digestion process removes secondary silver phases. After the post synthesis digestion process, ammonium hydroxide (NH₄OH) is added to dissolve silver (Ag) phases. The dissolved silver is subjected to centrifugation and then washed with distilled water (dH₂O).

Metal-Modified Cerium Oxide Nanoparticle (AgCNP2)

Using a forced hydrolysis reaction, a solution containing silver-modified nanoceria and silver secondary phases were formed, hereinafter referred to as “material.” The material was washed with distilled water. Then the washed material is treated with ammonium hydroxide (NH₄OH). The material was also treated with a phase transfer complex: mediating aqueous dispersion of dissolved silver, (Ag[(NH₃)₂OH]aq). After treatment, the treated material was washed again, such as by distilled water. Particle separation processes may be applied in lieu of a washing treatment. In another synthesis that yields silver modified nanoceria, silver nitrate (AgNO₃) and cerium (Ce) are dissolved to form a mixture. Then the mixture is dissolved by hydrogen peroxide (H₂O₂) which causes selective oxidation of Ce³⁺ over silver and the evolution of metallic silver phases on the ceria surface.

The formula properties for AgCNP1 and AgCNP2 are shown below in Table 1.

TABLE 1

| | | | Inorganic Crystal |
|---|---|---|---|
| | | | Structure Database |
| | AgCNP2 | AgCNP1 | No. (ICSD #) |
| Ce^{3+:}Ce⁴⁺ | 53.7 | 25.8% | |
| (% Ce³⁺)(%) | | | |
| [Ag]/Ag + Ce] | 14.6 | 16.9% | |
| by XPS(%) | | | |
| SOD Activity | 99.2 | 97.9% | |
| (% Inhibition) | | | |
| Hydrodynamic | 31.6 ± 2.4 | 42.2 ± 4.6 | |
| Diameter (nm) | | | |
| Zeta Potential (mV) | 24.1 ± 1.3 | 22.4 ± 0.9 | |
| ICPMS Ce | 299.2 ± 1.3 | 342.5 ± 2.3 | |
| concentration (ppb) | | | |
| ICPMS Ag | 74.9 ± 1.21 | 24.1 ± 1.03 | |
| concentration (ppb) | | | |
| E_{corr} (mV) | 217.374 | 465.386 | |
| Metallic Ag | | | 44387 |
| CeO₂ | | | 55284 |

A Zeta-sizer nano was used from Malvern Instruments to determine hydrodynamic diameters and zeta potentials. Tafel analysis for AgCNP2 shows distinct corrosion potentials. E_{corr} values are substantially more noble than pure silver.

A more detailed description of the process for forming AgCNP2 will now be described. First, about 109 mg of cerium nitrate hexa-hydrate (99.999% purity) is dissolved in about 47.75 mL dH₂O in a 50 ml square glass bottom. Then, about 250 μL of 0.2 M aq. AgNO₃ (99% purity) is added to the cerium solution above with the solution vortexed for 2 minutes: Machine: Vortexer. Then, about 2 mL of 3% hydrogen peroxide (stock) is added quickly to the above solution followed by immediate vortexing for 2 minutes at highest rotation speed (in vortexer machine). This solution is stored in dark condition at room temperature with the bottle (50 mL square bottom glass) cap loose to allow for release of evolved gases; solutions are left to age in these conditions for up to 3 weeks (monitoring solution color change from yellow to clear) to create 50 ml total volume of the solution. Particles are then dialyzed against 2 liters of dH₂O over 2 days, (dialysis Tubing) with the water changed every 12 hours and stored in the same conditions as for ageing.

The two unique formulations of cerium oxide nanoparticles are produced with surfaces modified by silver nanophases. Materials characterization shows that the silver components in each formulation are unique from each other and decorate the ceria surface as many small nanocrystals (AgCNP1) or as a Janus-type two-phase construct (AgCNP2). The average diameter of AgCNP1 is about 20 nm to 24 nm, and the average diameter of AgCNP2 is about 3 nm to 5 nm. However, the inventor prefers the use of AgCNP2. For example, AgCNP2 is preferred for high touch surfaces, including toilets, sinks, door handles, walls, faucets, hard surfaces, cages, etc. AgCNP1 may be used on floors, such as floors in public buildings, hospitals, restaurants, retail stores, government buildings, concert halls, or the like. AgCNP1 may be used on hard or soft surfaces with lower touch frequency by humans or animals. The AgCNP1 type NanoRAD ingredient may be a cheaper alternative to the AgCNP2 type NanoRAD ingredient and can be used in lieu of AgCNP2.

Each synthesis further possesses unique mixed valency with AgCNP2 possessing a significantly greater fraction of Ce3+ states relative to Ce4+ over AgCNP. The distinct valence characters, along with incorporation of chemically active silver phases, lead to high catalytic activities for each formulation. AgCNP2 possesses high superoxide dismutase activity, while AgCNP1 possesses both catalase and superoxide dismutase-like enzyme-mimetic activities, ascribed to the catalase activity of ceria and the superoxide dismutase activity from silver phases.

There are a variety of methods to synthesize nanoceria particles, including wet chemical, solvothermal, microemulsion, precipitation, hydrolysis and hydrothermal, such as described in S. Das, et al., “Cerium oxide nanoparticles: applications and prospects in nanomedicine,” Nanomedicine 8(9) (2013) 1483-1508 and C. Sun, et al. “Nanostructured ceria-based materials: synthesis, properties, and applications,” Energy & Environmental Science 5(9) (2012) 8475-8505, both of which are incorporated herein by reference. Based on the synthesis methodology employed, the size of these NPs varies broadly from 3-5 nm to over 100 nm, and the surface charge can vary from −57 mV to +45 mV.

Further, analysis demonstrates that silver incorporated in each formulation is substantially more stable to redox-mediated degradation than pure silver phases: promoting an increased lifetime in catalytic applications and low probability of ionization of the silver phase.

Use of AgCNP2 formulation in effecting antimicrobial properties showed specific activity in tests associated with bacteria with, among bacteria species tested, AgCNP2 showing substantial activity towards Staphylococcus mutants, such as Staphylococcus aureus.

Although the amount is not intended to be limiting, when used in methods of the invention, some preferred amounts of silver percentages associated with the AgCNPs are about 8% to 15% or less.

In other embodiments, disclosed is a method of producing mCNPs, as described herein, that may include the metal of silver. Further the AgCNP2 is produced via a method comprising dissolving cerium and silver precursor salts such as cerium and silver nitrates; oxidizing the dissolved cerium and silver precursor salts via admixture with peroxide; and precipitating nanoparticles by subjecting the admixture with ammonium hydroxide. Alternatively, the AgCNPs are produced via a method comprising (i) dissolving cerium and silver precursor salts such as cerium and silver nitrates; (ii) oxidizing and precipitating the dissolved cerium and silver precursor salts via admixture with ammonium hydroxide; (iii) washing and resuspending precipitated nanoparticles in water; (iv) subjecting the resuspended nanoparticles with hydrogen peroxide; and (v) washing the nanoparticles from step (iv) to remove ionized silver. For example, the removed ionized silver may be in the range of 3-5 nm in size.

In some embodiments, the AgCNP2 of the NanoRAD ingredient is produced via a method comprising dissolving cerium and silver precursor salts such as cerium and silver nitrates and oxidizing the dissolved cerium and silver precursor salts.

### Applications

The NanoRAD ingredient mCNPs, AgCNP1 or AgCNP2 can be combined into a composite with many forms of long-lasting coating compositions for surfaces that may be applied to the surfaces of consumer products, medical product and especially surfaces with high touch exposure. The long-lasting coating compositions may include polyurethane coatings such as those manufactured by Sherwin-Williams as clearcoat urethane products, urethane-based clearcoat products, or topcoat product for painting or covering surfaces of concreate, cabinets, automobiles, trucks, marine vehicles, aircraft vehicles and other surface compositions. A coating composition with a NanoRAD ingredient, such as mCNPs, AgCNP1 or AgCNP2, may be referred to as a NanoRAD coating or NanoRAD coating composition. The coating composition may include paint. Paint may have pigmentation for coloring, additives and binders. Paint may also have solvents and surfactants. As used herein paint is a durable adhesive coating once cured. The term “durable” as used herein means that the paint once cured can be repeatedly cleaned with a disinfectant, soap, cleaner or water to wash away bodily fluids, organic matter, organic or inorganic food matter, dirt, dust, and/or contaminants on a surface of the paint. In other words, the paint has a useful life and the cured paint is resistant to degradation from application of cleaning products and/or wiping of the cleaning products from the cured paint.

A durable adhesive coating once cured has a strong bond between the coating composition and a substrate of an article of manufacture to which the coating is applied and cured.

The NanoRAD ingredient mCNPs, AgCNP1 or AgCNP2 can be combined with POLYOX™ by DuPont, for example, to form a NanoRAD coating. The mCNPs, AgCNP1 or AgCNP2 may be combined with organic solvent-soluble polymers such as polyurethanes, acrylic polymers, polyamides, or combinations thereof to form a NanoRAD coating. An example of organic solvent-soluble polymers is described in U.S. Pat. No. 8,124,169, titled “ANTIMICROBIAL COATING SYSTEM,” assigned to 3M Innovative Properties Company, which is incorporated by reference. Examples of organic solvent-soluble polymers may include toluene, ESTANE® 5715, ESTANE® 5778, EPDXOL®CA118, NEOCRYL® XK-90, NEOCRYL® XK-95, NEOCRYL® XK-96, NEOREZ® R-960 AND NEOREX® R-9699. The NanoRAD ingredients of AgCNP1 or AgCNP2 may have a weight percent loading less than about 1 weight %.

The coating composition may include cross-linkable polymer ingredients to form a durable coating layer upon evaporation of water, for example, such as the result of drying and/or curing the coating composition. An example of cross-linkable polymer ingredients is also described in U.S. Pat. No. 8,124,169.

The NanoRAD coating in some embodiments may be generally permanent until a coating remover is applied to the layer of coating composition in order to remove such coating composition. Light abrasion may cause wear to the NanoRAD coating which affects the useful life of the coating composition to be self-cleaning.

The NanoRAD coating may include a colloidal or emulsion polymeric medium such as a polyurethane, an acrylic, a polyester, a vinyl, or combinations thereof. The colloidal or emulsion polymeric medium may have resin particles within a range of 1 micron or less in diameter, contingent on the ability to homogeneously distribute relatively evenly metal mediated nanoceria (i.e., NanoRAD ingredient) in the final coating medium. The NanoRAD ingredient may be mCNPs or AgCNP2 with a weight percent loading less than about 1 weight % and an average diameter between 25 nm to 35 nm. The NanoRAD ingredient may be mCNPs or AgCNP1 with a weight percent loading less than about 1 weight % and an average diameter of about 10 nm to 20 nm.

The NanoRAD coating may include a polyurethane coating, 30% solids, incorporating a NanoRAD ingredient, which are homogenized with relatively even distribution into a mixture. The NanoRAD ingredient may be mCNPs or AgCNP2 with a weight percent loading less than about 1 weight % and an average diameter of about 3 nm to 25 nm. The NanoRAD ingredient may be mCNPs or AgCNP1 with a weight percent loading less than about 1 weight % and an average diameter of about 20 nm to 50 nm.

The NanoRAD coating may be a polyester coating, 33% solids, used with a NanoRAD ingredient, which are homogenized with relatively even distribution into a mixture. The NanoRAD ingredient may be mCNPs or AgCNP2 with a weight percent loading less than about 1 weight % and an average diameter of about 3 to 25 nm. The NanoRAD ingredient may be mCNPs or AgCNP1 with a weight percent loading less than about 1 weight % and an average diameter of about 20 nm to 50 nm. By way of non-limiting example, the polyester coating may be applied and bound to fibers found in fabrics, textiles and carpet.

The coating composition may include an acrylic coating, 30% solids, used with a NanoRAD ingredient, which are homogenized with relatively even distribution into a mixture of mCNPs or AgCNP2 with a weight percent loading less than about 1 weight % and an average diameter of about 3 to 25 nm. The NanoRAD ingredient may be mCNPs or AgCNP1 with a weight percent loading less than about 1 weight % and an average diameter of about 20 nm to 50 nm.

An example of colloidal polymeric mediums is described in U.S. Pat. No. 8,282,951, titled “ANTIMICROBIAL COATINGS FOR TREATMENT OF SURFACES IN A BUILDING SETTING AND METHOD OF APPLYING SAME,” assigned to EnviroCare Corporation, which is incorporated herein by reference.

The long-lasting coating compositions herein may include other ingredients such as, without limitations, a fluorescing additive that is UV activated within the coating and emits visible light when not activated. The fluorescing additive may fluoresce in the presence of a UV light so that the remaining useful life (RUL) of the coating may be seen. For example, the coated surface may be inspected daily, weekly, monthly, etc. The occurrence of a non-fluorescing area provides an indication of areas that needs a reapplication of the coating composition to maintain antimicrobial activity. In some embodiments, a region of interest (ROI) on the surface with the non-fluorescing area may be selected where only the non-fluorescing area is re-coated. In other embodiments, the cured coating in the ROI is removed and then a new layer of the coating is reapplied and cured. In other embodiments, the ROI is coated with a second layer of the coating to cover the non-fluorescing area.

Any of the NanoRAD coatings described herein may also include a fluorescing additive. The fluorescing additive may include orange, yellow, red, blue, green, pyranine, fluorescein or Rhodamine B pigment. An example of coating with a fluorescing additive is described in Australian Patent No. 656165, titled “A FLUORESCENT COATING,” which is incorporated herein by reference. The mCNPs, AgCNP1 or AgCNP2 may be combined, for example, in suitable coatings of paint that can be activated to fluoresce and to provide self-cleaning properties.

Any of the NanoRAD coatings described herein may include a near infrared (NIR) up-conversion salt or a visible up-conversion salt. The NIR up-conversion salt is hereinafter referred to as a “NIR additive.”

In the case of a NIR additive, the interrogating light may be a NIR light source so that the NIR additive has a visible emission. By way of non-limiting example, a doped NaYF₄ nanomaterial may be irradiated with a low power NIR light and then imaged to capture the infrared emission and its profile in red, green, blue (RGB) with a normal visible camera, where Na is sodium; Y is Yttrium; and F is Fluorine.

Any of the NanoRAD coatings described herein may include surfactants to improve miscibility between the nanoparticles (AgCNP2) and the adherent coating polymer, such as urethane, and improve the overall wetting behavior of the coating formulation. The coatings may include ethyl ketone.

The coating composition may include a nano composite photocatalytic containing solvents for rapid evaporation at room temperature, such as, polyalkylphenylsiloxane, xylene, nano densified hydrophilic fumed silica, and nanostructured composite photocatalyst powder. An example of photocatalytic composite is described in U.S. Publication No. 2007/0000407, titled “NANO COMPOSITE PHOTOCATALYTIC COATING,” to inventor Leong, which is incorporated herein by reference.

In some embodiments, the coating composition for the NanoRAD coating may include an epoxy with a surfactant.

The coating composition for the NanoRAD coating may be configured to provide an outer self-cleaning layer on a paper product. The coating composition may be an added ingredient to an outer protective layer to render the outer protective layer self-cleaning. While the outer protective layer may be cleaned of organic matter, the coating composition is continuously acting as a self-cleaner for the outer protective layer. An example protective layer is described in European Patent No. 2962858, titled “ANTIBACTERIAL COATING,” to Touch Guard Ltd., which is incorporated herein by reference. In lieu of antibacterial additives, the coating would instead use mCNPs, AgCNP1 or AgCNP2.

In some embodiments, the coating composition for the NanoRAD coating may include at least one of a stabilizer (to prevent coating degradation over its lifetime), pH buffer, pigment, organic filler, surfactant, polyvinyl alcohol polymethyl methacrylate, polymethyl-co-poly butyl methacrylate, thermosetting polymers, and epoxy resins.

The coating composition for the NanoRAD coating may include a sealant, varnish, resin, bonding agent and coalescing solvent. Example methods for forming coatings are described in EP No. 1973587, titled “METHODS AND SYSTEMS FOR PREPARING ANTIMICROBIAL FILMS AND COATINGS,” to inventors Whiteford et al., which is incorporated herein by reference.

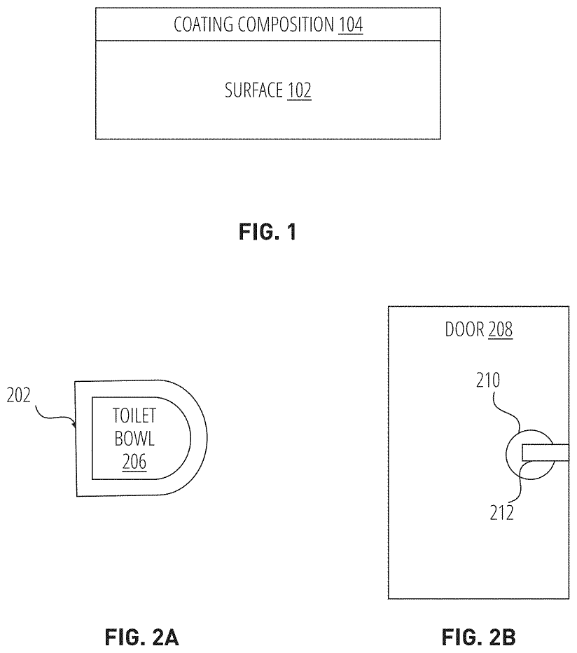

FIG. 1 shows a surface 102 of an article coated with a coating composition 104 such as a NanoRAD coating, as described herein. The surface 102 may be any hard surface such as cabinets, walls, sinks, toilets, countertops, floors, cars, ships, marine surfaces, computing devices, electronic devices, furniture, doorknobs, faucets, hospital beds, night tables, appliances, toys, and more. The surface 102 may include man-made materials, metal, porcelain, ceramic, cement, wood, engineered wood, and engineered synthetic materials, for example. The surface 102 may include a soft surface made of fibers, such as fabric, textile and carpet. The coating composition 104 may include urethane-based clearcoat ingredients that are suitable for the particular surface application.

The soft surface may be made of fibers, paper or soft plastics or synthetic ingredients such as used to cover menus. The soft surface may be a porous surface.

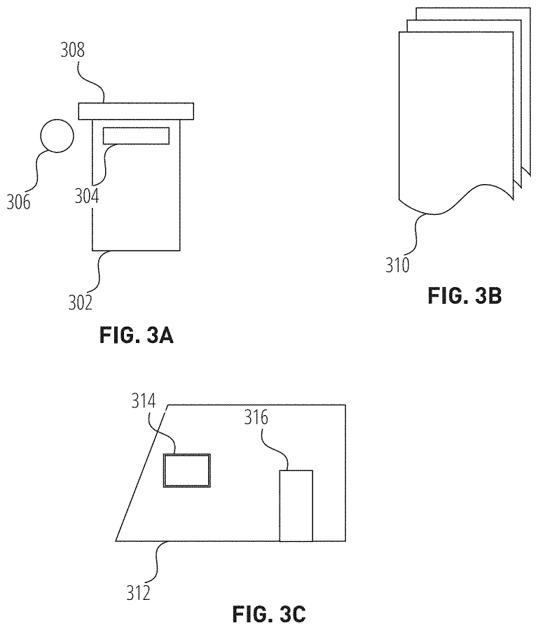

Example articles are shown in FIGS. 2A, 2B and 3A-3C. As should be understood, showing, and describing each and every possible article is prohibitive.

FIG. 2A illustrates a toilet seat 202 coated with a coating composition, such as a NanoRAD coating, in accordance with one embodiment. The toilet seat 202 may be mounted on a toilet bowl 206. The toilet bowl 206 may be made of porcelain while the toilet seat 202 may be made of plastic, wood, or synthetic materials. Both the toilet seat 202 and toilet bowl 206 may be coated with different coating compositions 104.

FIG. 2B illustrates a door 208 with a door handle 212 affixed to a plate 210 in accordance with one embodiment. The door 208 may be coated with a first coating composition 104, such as a NanoRAD coating, while the door handle 212 and plate 210 may be coated with a second coating composition 104, such as another NanoRAD coating, different from the first coating composition.

FIG. 3A illustrates furniture such as nightstand 306 and headboard 308 coated with a coating composition, such as a NanoRAD coating, in accordance with one embodiment. In some embodiments, the headboard 308 is attached to a bed 302 having a pillow 304. The nightstand 306 and headboard 308 may be coated with a coating composition 104. In some embodiments, the nightstand 306 and headboard 308 may be made of similar material which is suitable for using a coating composition 104 of the same type. In other instances, the nightstand 306 and headboard 308 may be made of different types of material requiring different NanoRAD coating compositions 104.

FIG. 3B illustrates fabric 310 coated with a NanoRAD coating in accordance with one embodiment. The fabric 310 may include fibers that are configured to be coated with a coating composition 104. The fabric 310 may be used for curtains, for example, in a hospital, office, hotel, public location, residence, or building. The fabric 310 may be used on soft surfaces, such as cushion chairs, sofas, beds, and the like. The fabric may include soft, porous surfaces.

The fabric 310 may be made into a paper product.

The fabric may be a synthetic fabric. The coating composition may include a dye where the fabric is treated and colored with the coating composition.

The coating composition may be applied by dipping the fabric in an amount of the coating composition so that the soft, porous surfaces absorb the coating composition.

The coating composition may be poured on the fabric or painted.

FIG. 3C illustrates an interior wall 312 of a building having a door 316 and a window 314 in accordance with one embodiment.

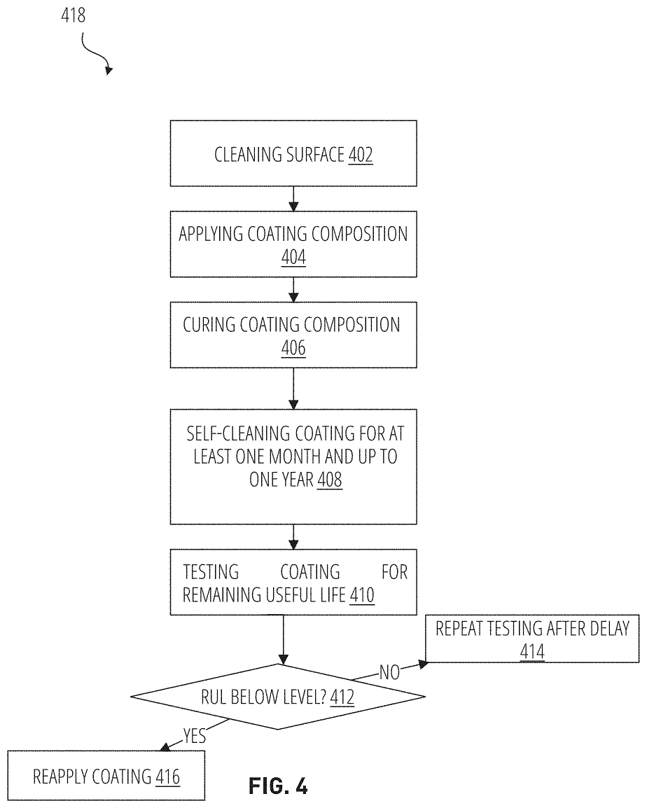

FIG. 4 illustrates a flowchart of a process 418 for coating a surface in accordance with one embodiment. The process 418, in block 402, may include cleaning a subject surface. While it may be recommended to clean the subject surface with a cleaner to remove bacteria and organic material, it may be impossible to remove all bacteria and resistant bacteria. The NanoRAD coating described herein eradicates bacteria and biofilms on the surface after the NanoRAD coating is applied and permanently affixed, for example.

In block 404, the process 418 may include applying a NanoRAD coating composition to the subject surface. In block 406, the process 418 may include curing or hardening the NanoRAD coating composition to form and affix the NanoRAD coating to the surface of the article. In some embodiments, the curing is performed using a UV light, for example, having a wavelength range of 200 nm to 400 nm. The NanoRAD coating composition 104 may harden or cure in response to an application of UV light in the wavelength range of 200 nm to 400 nm over a period of time. In other embodiments, the NanoRAD coating composition 104 may be hardened or cured in response to an evaporation of water or application of radiated heat.

In block 408, the process 418 may include continuously and autonomously self-cleaning and/or self-disinfecting the NanoRAD coating for at least one month and up to one year. In block 410, the process 418 may include testing the NanoRAD coating for remaining useful life (RUL). It should be understood that the NanoRAD coating may be cleaned using commercially available cleaners, such as those applied by spraying and wiping, to remove organic material that may be deposited from interaction with humans or animals. Such cleaning is secondary to the self-cleaning and/or self-disinfecting by the NanoRAD coating to eradicate bacteria, viruses, and biofilms, for example.

In decision block 412, a determination is made whether the RUL is below a level. If the determination is “NO,” then at block 414, the process 418 may include repeat testing after a delay, for example, testing may be repeated daily, weekly, monthly, quarterly, etc. The delay may vary based on the determined RUL level. If the determination is “YES,” then, at block 416, the process 418 may include reapplying the coating composition.

The RUL level may be determined using image processing, where the pixels are analyzed based on the appearance of the fluorescing additive. For example, in a region of interest (ROI), if 5% (RUL threshold) of the pixels are not fluorescing, the NanoRAD coating may need to have a new application of the NanoRAD coating over the existing NanoRAD coating. In other examples, the NanoRAD coating in the ROI is greater than the RUL threshold, the entire coating in at least the ROI may be removed so that a new NanoRAD coating can be reapplied. The RUL threshold may be between 5% and 10%. In other embodiments, the RUL threshold may vary based on the article and exposure to frequency of touch by humans or animals.

The coating method may be applied during the manufacturing process of a hard or soft surface article or in the building. In some embodiments, the coating may be sprayed on to the surface. In other embodiments, the coating may be applied in any manner as a paint is applied, such as with a paint brush. During the manufacturing process, the NanoRAD coating composition may be applied during an additive manufacturing process. The coating may be applied by painting, pouring or dipping.

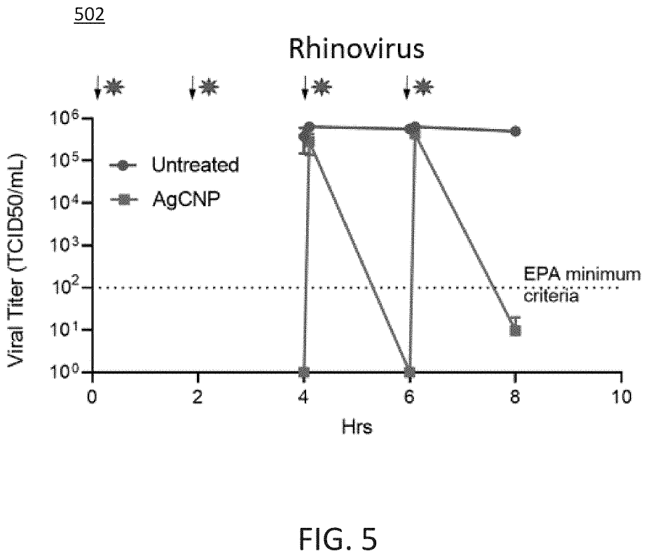

FIG. 5 illustrates a graph 502 of a viral titer such as rhinovirus over surface treated with AgCNP2 in accordance with one embodiment. The viral count (TCID50/ml) of a viral titer introduced at 0, 2, 4, and 6 hours to dry test surfaces, with infectious remaining virus analyzed at 4, 6, and 8 hours. Over time the untreated coupons with rhinovirus remains above 105 between 4 and 8 hrs. verifying experimental controls. The graph 502 shows a paired film of metal-modified nanoceria (AgCNP2) taken at 4 hrs., 6 hrs., and 8 hrs. At 4 and 6 hours the viral titer is non-detectable showing viral eradication. At the 8-hour mark (4 viral loads of >105) was ˜10¹ (99.99% reduction), which is below the U.S. Environmental Protection Agency (EPA) minimum criteria (99.9%) for disinfection with residual antimicrobials.

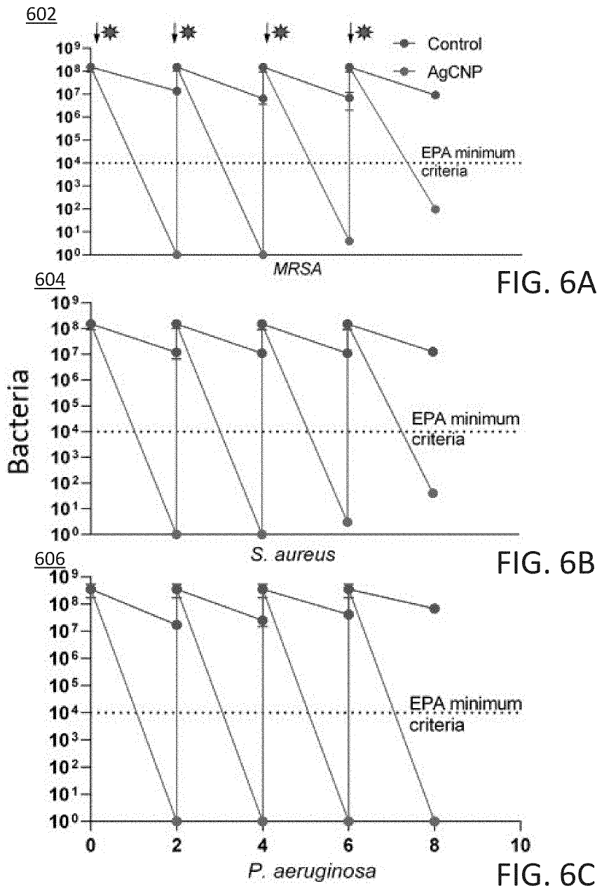

FIGS. 6A-6C illustrate three graphs 602, 604 and 606 of MSRA, Staphylococcus aureus, and Pseudomonas aeruginosa, respectively, treated with AgCNP2 in accordance with one embodiment. The bacterial count (CFU/ml) is at least 108 of a liquid bacterial load introduced to dry test surfaces at 0, 2, 4 and 6 hours, measured over time, for a control bacteria of MSRA, Staphylococcus aureus, or Pseudomonas aeruginosa, and a paired film of metal-modified nanoceria (AgCNP2). Bacterial count was analyzed at 2, 4, 6 and 8 hours. In the case of Pseudomonas aeruginosa, eradication (>99.99999%) was seen at each time point. For MRSA and Staphylococcus aureus, eradication (>99.9999999%) at the 2 and 4-hour marks, while at the 6 and 8-hour mark, surviving bacteria was reduced by >99.999%. In each case, the bacteria paired with AgCNP2 reduced below the EPA minimum criteria (99.9% for disinfection with residual antimicrobials) and remained below the criteria at 2, 4, 6 and 8 hours for example.

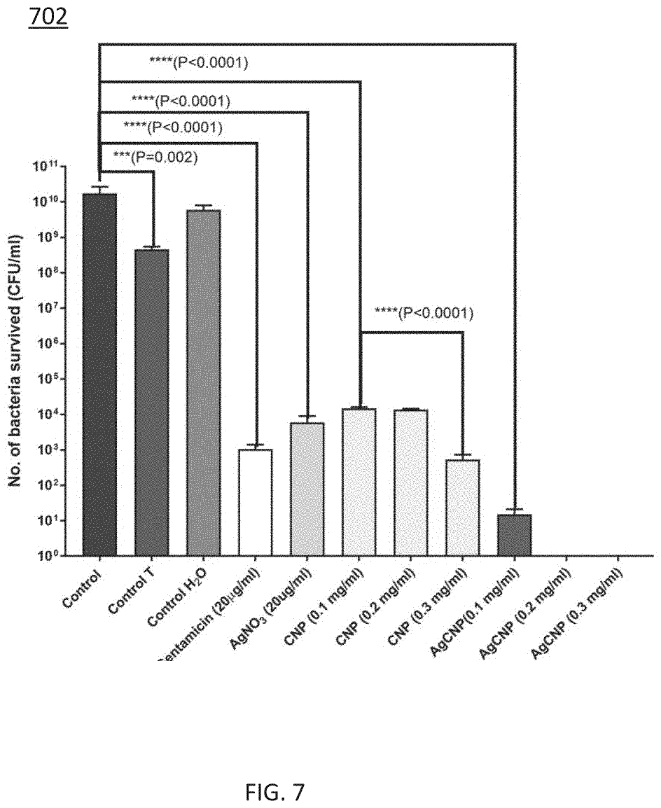

FIG. 7 illustrates a bar graph 702 of Pseudomonas aeruginosa biofilm treated with AgCNP2 in accordance with one embodiment. The bacterial count (CFU/ml) of the test shows bars measurements for a control (LB agar), a control T (tris/NaCl), water (H₂O), gentamicin at 20 ug/ml (MIC), silver nitrate (AgNO₃) at 20 ug/ml (equivalent dose to silver in 0.2 mg/ml of AgCNP2), CNP at 0.1 mg/ml, CNP at 0.2 mg/ml, CNP at 0.3 mg/ml, AgCNP2 at 0.1 mg/ml, AgCNP2 at 0.2 mg/ml and AgCNP2 at 0.3 mg/ml. Reductions in survivable bacteria within the biofilm were monitored over a 3-day period. AgCNP2 (0.2 mg/ml) showed eradication of the biofilm by day 3, with a 99.99999999% reduction in survivable bacteria. Comparison was done with a non-metal mediated nanoceria (CNP) as well as an equivalent dose of silver salt to verify activity was due to metal mediation of nanoceria. AgCNP2 outperformed AgNO₃ CNP by ˜10,000× at the end of day 3.

Although the test results herein are for AgCNP2, the mCNPs or AgCNP1 ingredient is expected to also be self-disinfecting and eradicating biofilms.

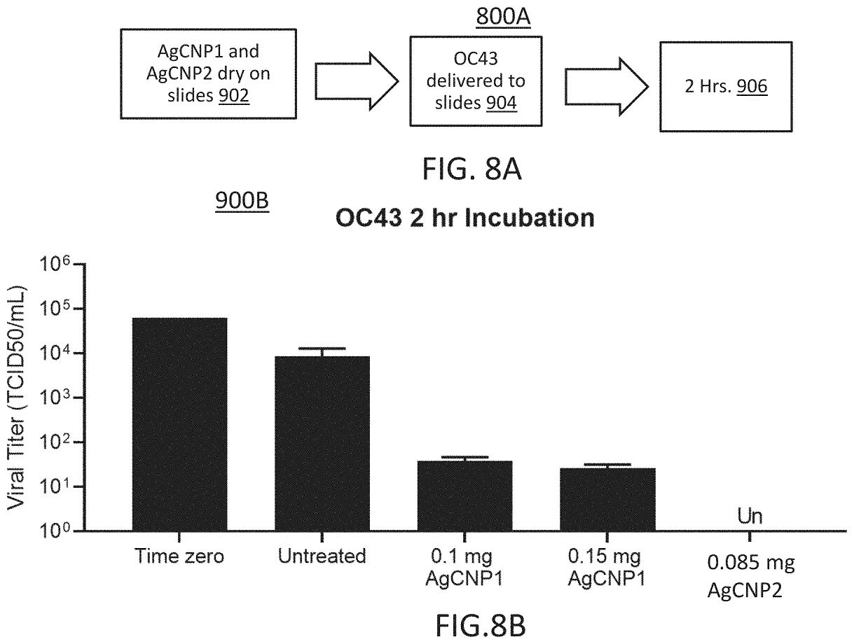

FIG. 8A illustrates a flow diagram of a testing process 800A for viruses, such as SARS-CoV-2 surrogate OC43 coronavirus, in accordance with an embodiment. The process includes, at block 802, drying a solution having a PetOx (binder) compound and a mCNP ingredient of: AgCNP1 in the amount of 0.1 mg on a first slide; AgCNP1 in the amount of 0.15 mg on a second slide; or AgCNP2 in the amount of 0.085 mg on a third slide.

The process may include, at block 804, delivering SARS surrogate OC43 to each of the first, second and third slides. The process may include, at block 806, incubating for 2 hours the slides with the combined SARS-CoV-2 surrogate OC43 coronavirus and mCNP ingredient. The process also delivered SARS-CoV-2 surrogate OC43 coronavirus as a control to an untreated slide.

FIG. 8B illustrates a graphical representation 800B of a test of AgCNP1 and AgCNP2 dried on a slide after a 2-hour incubation with SARS-CoV-2 surrogate OC43 coronavirus.

The untreated slide after 2 hours of incubation had a viral titer of slightly less than 104 mean tissue culture infectious dose (TCID 50/mL). The slide with SARS-CoV-2 surrogate OC43 coronavirus and the solution with the mCNP ingredient of AgCNP1 in the amount of 0.1 mg after 2 hours of incubation have a viral titer of about 1.5×102. The slide with SARS-CoVo2 surrogate OC43 coronavirus and the solution with the mCNP ingredient of AgCNP1 in the amount of 0.15 mg after 2 hours of incubation have a viral titer of about 1.4×102. The slide with SARS-CoV-2 surrogate OC43 coronavirus and the solution of the mCNP ingredient of AgCNP2 in the amount of 0.085 mg after 2 hours of incubation have a viral titer that was undetectable (Un).

The fabrics could be a 2 or 3-ply variation for respiratory viruses (rhinovirus, influenza, coronavirus, etc.).

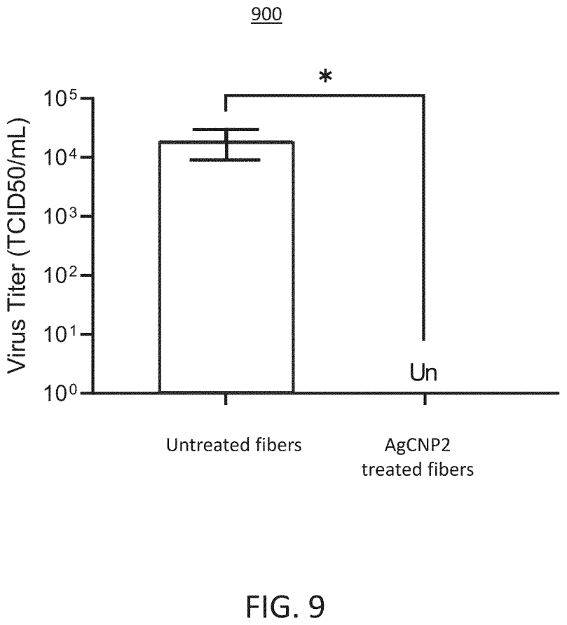

FIG. 9 illustrates a graphical representation 900 of a test that includes fibers treated with a polymeric binder that include 0.01 wt % of AgCNP2 (right) compared to untreated fibers (left) after a 2-hour incubation with human Rhinovirus 14 (HRV14) (left and right) on dry fabric. After 2 hours, no infectious (surviving) human Rhinovirus 14 virus (HRV14) was found on the fibers.

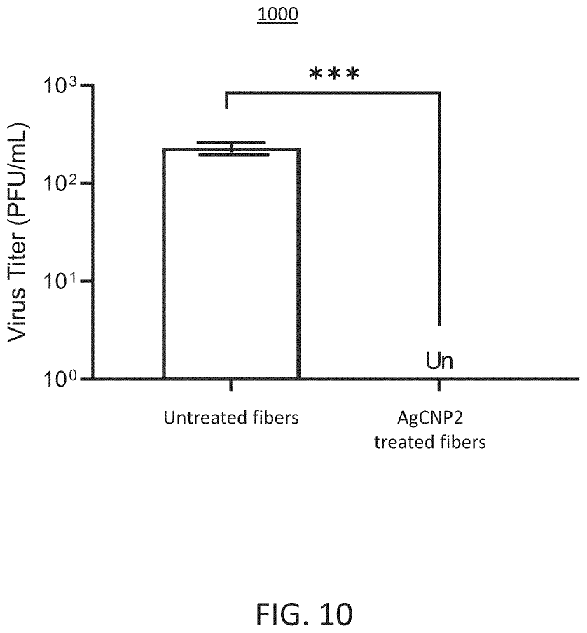

FIG. 10 illustrates a graphical representation 1000 of a test that includes fibers treated with a polymeric binder that includes 0.01 wt % AgCNP2 (right) compared to untreated fabric (left) after a 2-hour incubation with Parainfluenza virus type 5 (PIVS) (left and right) on dry fibers. After 2 hours, no infectious (surviving) Parainfluenza virus type 5 (PIVS) was found on the fibers.

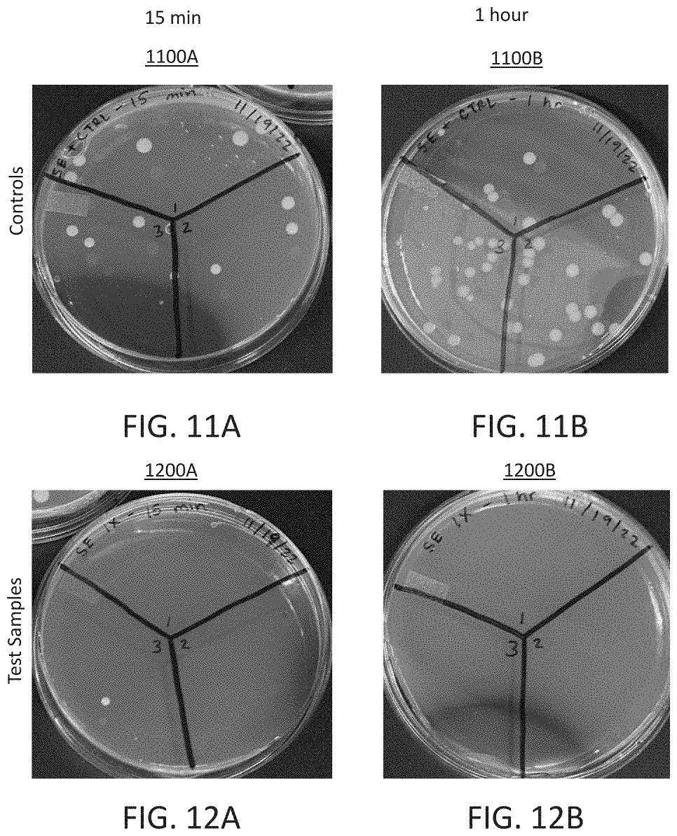

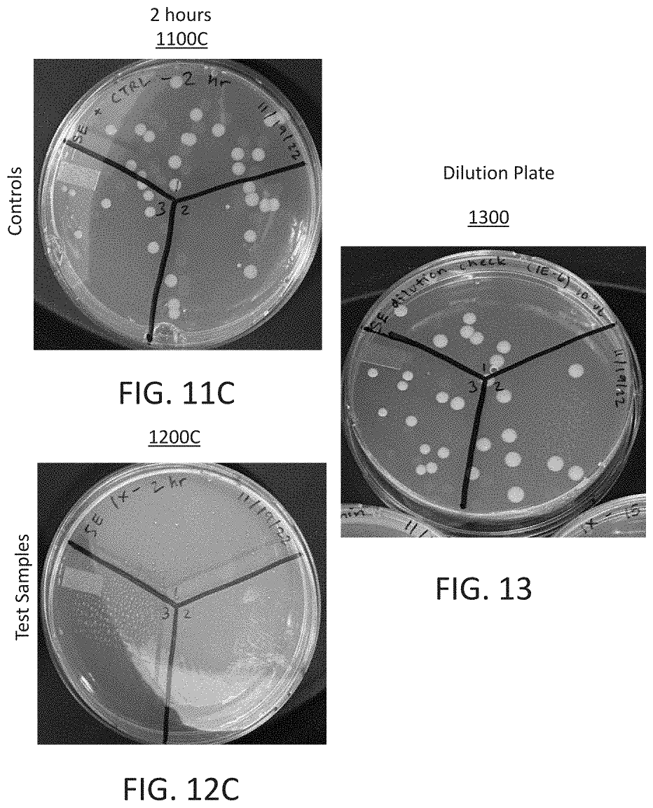

FIGS. 11A-11C illustrate photographs 1100A, 1100B and 11000 of S. epidermidis dried on a control surface coupons shown in triplicate (3 plate sections) at 15, 60 and 120 minutes, respectively, of bacterial challenge.

FIGS. 12A-12C illustrate photographs 1200A, 1200B and 1200C of S. epidermidis dried on NanoRAD (AgCNP2 in polyurethane) treated coupons shown in triplicate (3 plate sections) at 15, 60 and 120 minutes, respectively, of bacterial challenge. After 60 minutes (1 hour) there were no surviving bacteria found.

FIG. 13 illustrates a photograph 1300 of S. epidermidis on a dilution plate.

The above description relates to, for example, existing non-self-cleaning surfaces whether hard or soft.

A coating composition may comprise mCNPs ingredient having metal-associated cerium oxide nanoparticles and a paint. The metal is selected from the group consisting of silver, gold, copper, platinum, nickel, zinc, iron, titanium, ruthenium, vanadium, and the like.

A coating composition also may comprise a fluorescing additive or a NIR additive.

The metal comprises silver.

The coating composition may comprise the silver is in an amount of 10% or less by weight of the NanoRAD ingredient (i.e., mCNPs ingredient).

The coating composition may comprise AgCNP1 with a weight percent loading less than about 1 weight % and an epoxy.

The coating composition may comprise mCNPs ingredient with a predominantly 3+ surface charge and at least one of paint, epoxy, polyurethane, an acrylic, a polyester and a vinyl.

The coating composition may comprise mCNPs with predominantly 4+ surface charge and at least one of paint, epoxy, polyurethane, an acrylic, a polyester and a vinyl.

The mCNPs ingredient may be AgCNP2 with a weight percent loading less than about 1 weight % and the mCNPs may have an average diameter of about 3 nm to 25 nm.

The mCNPs ingredient may be AgCNP1 with a weight percent loading less than about 1 weight % and the mCNPs may have an average diameter of about 20 nm to 50 nm.

The coating composition may comprise mCNPs with predominantly 4+ surface charge, fluorescing additive, and a UV curable epoxy where the mCNPs ingredient has a weight percent loading less than about 1 weight %.

The coating composition may comprise mCNPs with predominantly 3+ surface charge, a fluorescing additive, and a UV curable epoxy where the mCNPs ingredient has a weight percent loading less than about 1 weight %.

The coating composition may comprise mCNPs ingredient with a predominantly 3+ surface charge and a colloidal polymeric medium where the mCNPs ingredient has a weight percent loading less than about 1 weight %.

The coating composition may comprise mCNPs with predominantly 4+ surface charge and a colloidal polymeric medium where the mCNPs ingredient has a weight percent loading less than about 1 weight %.

The coating composition may comprise mCNPs with predominantly 3+ surface charge and a cross-linkable polymer where the mCNPs ingredient has a weight percent loading less than about 1 weight %.

The coating composition may comprise mCNPs with predominantly 4+ surface charge and a cross-linkable polymer where the mCNPs ingredient has a weight percent loading less than about 1 weight %.

The coating composition may comprise mCNPs with predominantly 3+ surface charge and a clearcoat urethane where the mCNPs ingredient has a weight percent loading less than about 1 weight %.

The coating composition may comprise mCNPs with predominantly 4+ surface charge and a clearcoat urethane where the mCNPs ingredient has a weight percent loading less than about 1 weight %.

The coating composition may comprise mCNPs with predominantly 4+ surface charge and one of a sealant, varnish, resin, bonding agent, and coalescing solvent where the mCNPs ingredient has a weight percent loading less than about 1 weight %.

The coating composition may comprise mCNPs with predominantly 4+ surface charge and a nano composite photocatalytic containing solvents for rapid evaporation at room temperature where the mCNPs ingredient has a weight percent loading less than about 1 weight %.

The coating composition may include at least one of a potential hydrogen (pH) buffer, pigment, organic filler, surfactant, polyvinyl alcohol polymethyl methacrylate, polymethyl-co-poly butyl methacrylate, thermosetting polymers and epoxy resins.

An article of manufacture comprises a hard surface having a NanoRAD coating thereon, the coating having a coating composition, as defined herein.

An article of manufacture comprises a soft surface having a NanoRAD coating thereon, the coating having a coating composition, as defined herein.

A method of disinfecting a surface comprises coating the surface with a NanoRAD coating composition, and curing the coating composition to form a self-disinfecting coating on the surface, the self-disinfecting coating on the surface eradicates bacteria biofilms at least by >99.999%. The coating composition may be cured with a UV light or harden by drying.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

Embodiments are described herein with reference to the attached figures wherein like reference numerals are used throughout the figures to designate similar or equivalent elements. In some instances, figures are not drawn to scale and they are provided merely to illustrate aspects disclosed herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

What is claimed is:

1. A long-lasting and mechanically stable coating composition comprising:
metal-modified cerium oxide nanoparticles (mCNPs) ingredient selected from a group consisting of predominantly 3+ surface charge and predominantly 4+ surface charge, where m is an antimicrobial promoting metal; and
a paint where the mCNPs ingredient has a weight percent loading less than about 1 weight % in a mixture with the paint that is a durable adhesive coating once cured.

2. The coating composition according to claim 1, wherein the antimicrobial promoting metal is silver in an amount of 15% to 8% by weight.

3. The coating composition according to claim 1, wherein the antimicrobial promoting metal is selected from a group consisting of silver, gold, copper, platinum, nickel, zinc, iron, titanium, ruthenium and vanadium.

4. The coating composition according to claim 1, wherein the mCNPs ingredient has a predominantly 3+ surface charge with an average diameter of about 3 nanometers (nm) to 25 nm.

5. The coating composition according to claim 1, wherein the mCNPs ingredient has a predominantly 4+ surface charge with an average diameter of about 20 nanometers (nm) to 50 nm.

6. The coating composition according to claim 1, further comprising one of: a fluorescing additive, a near infrared (NIR) up-conversion salt and a visible up-conversion salt.

7. The coating composition according to claim 1, wherein the coating composition in a cured state eradicates bacteria biofilms at least by 99.9% or >99.999% and the paint comprises one of epoxy, polyurethane, a polyester and a urethane-based clearcoat.

8. The coating composition according to claim 1, further comprises:
a nano composite photocatalytic containing solvents for rapid evaporation at room temperature.

9. The coating composition according to claim 1, further comprises:
at least one of a pigment, pH buffer, polymethyl-co-poly butyl methacrylate, thermosetting polymers and epoxy resins.

10. An article of manufacture comprising:
a surface; and
a coating composition of claim 1, cured on the surface, the coating composition is self-disinfecting and pathogen eradicating.

11. The article of manufacture according to claim 10, wherein the antimicrobial promoting metal is silver in an amount of 15% to 8% by weight.

12. The article of manufacture according to claim 10, wherein the antimicrobial promoting metal is selected from a group consisting of silver, gold, copper, platinum, nickel, zinc, iron, titanium, ruthenium and vanadium.

13. The article of manufacture according to claim 10, wherein the mCNPs ingredient has a predominantly 3+ surface charge with an average diameter of about 3 nanometers (nm) to 25 nm.

14. The article of manufacture according to claim 10, wherein the mCNPs ingredient has a predominantly 4+ surface charge with an average diameter of about 20 nanometers (nm) to 50 nm.

15. The article of manufacture according to claim 10, wherein the coating composition further comprises one of: a fluorescing additive, a near infrared (NIR) up-conversion salt and a visible up-conversion salt.

16. The article of manufacture according to claim 10, wherein the coating composition in a cured state eradicates bacteria biofilms at least by 99.9% or >99.999% and the paint comprises one of epoxy, a polyester and a urethane-based clearcoat.

17. The article of manufacture according to claim 10, further comprises:
a nano composite photocatalytic containing solvents for rapid evaporation at room temperature.

18. The article of manufacture according to claim 10, further comprises:
at least one of a pH buffer, pigment, polymethyl-co-poly butyl methacrylate, thermosetting polymers and epoxy resins.

19. A method of disinfecting a surface comprising:
coating the surface with a coating composition of claim 1; and
curing the coating composition to form a self-disinfecting coating on the surface which eradicates bacteria biofilms at least by 99.9% or >99.999%.

20. The method according to claim 19, wherein the curing of the coating composition includes curing the coating composition with a UV light.

21. The method according to claim 19, wherein the curing of the coating composition includes curing the coating composition.

22. The method according to claim 19, wherein the coating composition further comprises one of: a fluorescing additive, a near infrared (NIR) up-conversion salt and a visible up-conversion salt.

23. The method according to claim 19, wherein the antimicrobial promoting metal is silver in an amount of 15% to 8% by weight.

24. The method according to claim 19, wherein the antimicrobial promoting metal is selected from a group consisting of silver, gold, copper, platinum, nickel, zinc, iron, titanium, ruthenium and vanadium and the paint comprises one of epoxy, polyurethane, a polyester and a urethane-based clearcoat.

25. The method according to claim 19, wherein the coating composition further comprises:
a nano composite photocatalytic containing solvents for rapid evaporation at room temperature.

26. The method according to claim 19, wherein the coating composition further comprises:
at least one of a pH buffer, pigment, polymethyl-co-poly butyl methacrylate, thermosetting polymers and epoxy resins.
